(19) United States
(12) Patent Application Publication
(10) Pub. No.: US 2018/0349781 A1
(43) Pub. Date: Dec. 6, 2018

(54) METHOD AND DEVICE FOR JUDGING NEWS QUALITY AND STORAGE MEDIUM

(71) Applicant: BEIJING BAIDU NETCOM SCIENCE AND TECHNOLOGY CO., LTD., Beijing (CN)

(72) Inventors: Zhihui Liu, Beijing (CN); Wei Bi, Beijing (CN); Yuhui Cao, Beijing (CN); Jingzhou He, Beijing (CN); Di Jiang, Beijing (CN)

(73) Assignee: BEIJING BAIDU NETCOM SCIENCE AND TECHNOLOGY CO., LTD., Beijing (CN)

(21) Appl. No.: 15/954,015

(22) Filed: Apr. 16, 2018

(30) Foreign Application Priority Data
Jun. 2, 2017 (CN) 201710407241.1

(51) Int. Cl. G06N 5/04; G06N 99/00

(52) U.S. Cl. CPC G06N 5/048; G06N 99/005

(57) ABSTRACT

Embodiments of the present disclosure disclose a method and a device for judging news quality based on AI and a storage medium. The method includes: constructing a news quality classification model based on a news feature of known high-quality news and/or a news feature of known low-quality news; and judging news quality of news to be detected with the news quality classification model.

### CROSS REFERENCE TO RELATED APPLICATION

This application is based on and claims priority of Chinese Patent Application No. 201710407241.1 filed on Jun. 2, 2017, the entire contents of which are incorporated herein by reference.

### TECHNICAL FIELD

Embodiments of the present disclosure relate to the Internet technology field, and more particularly, to a method and a device for judging news quality and a storage medium.

### BACKGROUND

Artificial intelligence (AI) is a new technical science studying and developing theories, methods, techniques and application systems for simulating, extending and expanding human intelligence. AI is a branch of computer science, which attempts to know the essence of intelligence and to produce an intelligent robot capable of acting as a human. The researches in this field include robots, speech recognition, image recognition, natural language processing and expert systems, etc.

Recently, Baidu (which is a Chinese multinational technology company specializing in Internet-related services and products, and AI, headquartered at the Baidu Campus in Beijing's Haidian District) brings “interactive news” by means of natural language processing technology, to realize more intelligent and natural content organization and reading experience. The “interactive news” aims to recommend high-quality and valuable news to users. Therefore, it is required to judge news quality to filter out low-quality news (such as, advertisement (ad), pornography, advertorial or the like).

At present, rules may be extracted manually from a plurality of news and then the low-quality news may be filtered out by matching the rules. However, the low-quality news has various representation forms. Taking the advertorial as an example, the advertorial is a “text-formed ad,” written by a marketing planner of a firm or a copywriter of an advertising company, such that publicity content and news content are combined perfectly, thereby enabling the user to understand the publicity content while the user is reading the news content. For such high-quality ad, such as the advertorial, it is hard to be distinguished by simply matching the rules. Therefore, a pure manual rule extraction not only consumes a large amount of manpower, but also hardly covers all low-quality news for the extracted rules, thereby resulting in low efficiency and low accuracy in judging the news quality.

### SUMMARY

In a first aspect, embodiments of the present disclosure provide a method for judging news quality based on AI. The method includes: constructing a news quality classification model based on a news feature of known high-quality news and/or a news feature of known low-quality news; and judging news quality of news to be detected with the news quality classification model.

In a second aspect, embodiments of the present disclosure provide an apparatus. The apparatus includes: one or more processors; a storage device, configured to store one or more programs; in which when the one or more programs are executed by the one or more processors, the above method is executed by the one or more processors.

In a third aspect, embodiments of the present disclosure provide a computer readable storage medium, having computer programs stored therein. When the computer programs are executed by a processor, the above method is realized.

### BRIEF DESCRIPTION OF THE DRAWINGS

FIG. 1 is a flow chart illustrating a method for judging news quality based on AI according to an embodiment of the present disclosure;

FIG. 2 is a flow chart illustrating a method for judging news quality based on AI according to another embodiment of the present disclosure;

FIG. 3 is a flow chart illustrating a method for judging news quality based on AI according to still another embodiment of the present disclosure;

FIG. 4 is a block diagram illustrating a device for judging news quality based on AI according to an embodiment of the present disclosure; and

FIG. 5 is a schematic diagram illustrating a computer apparatus according to an embodiment of the present disclosure.

### DETAILED DESCRIPTION

In order to make purposes, technical solutions and advantages of the present disclosure more apparent, detailed descriptions will be made to specific embodiments of the present disclosure with reference to drawings. It may be understood that, the specific embodiments of the present disclosure described herein merely serve to explain the present disclosure, and are not construed to limit the present disclosure.

In addition, it should also be noted that, for convenience of description, only parts related to the present disclosure are illustrated in the drawings, instead of all of the present disclosure. Before discussing exemplary embodiments in more detail, it should be mentioned that some exemplary embodiments are described as processes or methods depicted as the flow charts. Although various operations (or steps) described in the flow charts are sequential, many of these operations may be performed in parallel, concurrently, or simultaneously. In addition, a sequence of operations can be rearranged. The process may be terminated when its operations are completed, but may also have additional steps that are not included in the drawings. The process may correspond to methods, functions, procedures, subroutines, subprograms, and the like.

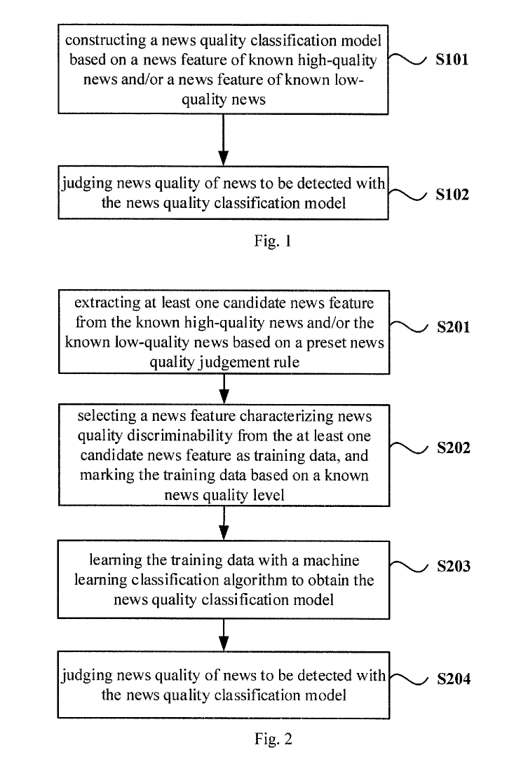

FIG. 1 is a flow chart illustrating a method for judging news quality based on AI according to an embodiment of the present disclosure. The embodiment may be applicable to a situation of judging the news quality. The method may be executed by a device for judging news quality based on AI provided in embodiments of the present disclosure. The device may be implemented in hardware and/or software. The device may be integrated into a terminal device or an application side of the terminal device. The terminal device may be, but not limited to, a mobile terminal (such as a tablet computer or a smart phone), a fixed terminal (such as a desktop computer or a laptop).

The application side may be a plug-in embedded a certain client of the terminal device, or may be a plug-in of an operating system of the terminal device, cooperating with a client embedded in the terminal device for judging the news quality based on AI or with an application program in the operating system of the terminal device for judging the news quality based on AI. Alternatively, the application side may also be a separate client in the terminal device, which is able to provide news quality judgment based on AI. The embodiments are not limited thereto.

As illustrated in FIG. 1, the method according to embodiments includes the followings.

In block 101, a news quality classification model is constructed based on a news feature of known high-quality news and/or a news feature of known low-quality news.

High-quality news refers to news that does not contain ad, pornography, reactionary or the like. Low-quality news refers to news that contains ad, pornography, reactionary and the like. In detail, at least one piece of the high-quality news can be acquired as the known high-quality news and/or at least one piece of the low-quality news can be acquired as the known low-quality news based on a manual judgment manner.

The news feature may contain at least one of: word frequency information, information on part of speech, proper name information and an emotion feature. The word frequency information is an occurrence times of a word in a title and/or in content of the whole news. The information on part of speech is a word class mark of the whole news, such as an adjective, a noun, a verb, an adverb and the like. The proper name is a brand name, a person's name, a company's name, a product's name or the like contained in the news. The emotion feature is an emotion tendency expressed by a news writer, for example praise or slander of a certain brand.

For the high-quality news, there must be individual news feature corresponding thereto accordingly. For the low-quality news, there also must be individual news feature corresponding thereto accordingly. Therefore, by constructing the news quality classification model based on the news feature of the known high-quality news and/or the news feature of the known low-quality news, the news quality may be judged better.

In block 102, news quality of news to be detected is judged with the news feature classification model.

In detail, the news to be detected or an extracted news feature of the news to be detected may be inputted into the news quality classification model for training and learning. The news quality classification model may directly output a classification result. The news to be detected may be judged as the high-quality news or the low-quality news based on the classification result.

In the embodiments, by constructing the news quality classification model based on the news feature of the known high-quality news and/or the news feature of the known low-quality news, and by judging the news quality of the news to be detected with the news quality classification model, a process of judging the news quality is smarter, thereby improving the efficiency and the accuracy in judging the news quality.

FIG. 2 is a flow chart illustrating a method for judging news quality based on AI according to another embodiment of the present disclosure. This embodiment is optimized on the basis of the above embodiment. In embodiments, constructing the news quality classification model based on the news feature of the known high-quality news and/or the news feature of the known low-quality news may be described as follows. At least one candidate news feature is extracted from the known high-quality news and/or the known low-quality news based on a preset news quality judgment rule. A news feature characterizing news quality discriminability is selected from the at least one candidate news feature as training data. The training data is marked based on a known news quality level. The training data is learned by adopting a machine learning classification algorithm to obtain the news quality classification model.

Accordingly, the method according to embodiments includes the followings.

In block 201, the at least one candidate news feature is extracted from the known high-quality news and/or the known low-quality news based on the preset news quality judgment rule.

The news quality judgment rule may include at least one of: whether brand information is contained, whether product information is contained, news publicity intention, an occurrence frequency of a product name and/or a brand name in an article, whether meaning indications of words are positive, and whether word styles are exaggerated.

Analysis and statistic may be performed on 500 pieces of high-quality news and 500 pieces of low-quality news in advance after the high-quality news and the low-quality news are marked, for mainly determining a brand contained in each piece of news and product publicity intention of each piece of news. If an occurrence frequency of a brand or a product's name in an article is very high, for example generally higher than a regular news report, it may be judged that the piece of news corresponding to the article is the low-quality news. Alternatively, if content of a piece of news has many adjectives, meaning expressions of verbs and adjectives are positive and energetic, and word styles are exaggerated (such as it is highly possible to contain the words “innovation”, “surmount”, “excellent”, “super”, “all-round”, “subversion” or the like in the advertorial), then it may be determined that the piece of news is the low-quality news. The above two cases are examples of mechanically judging the news quality. Alternatively, if the advertorial of a product defames other products in an, conceals well-known problems and questions of the product, and even expresses information contrary to common knowledge in publicity, then it is determined that the piece of news is the low-quality news. Otherwise, the piece of news is the high-quality news. Based on the above judgment rules, the at least one candidate news feature is extracted from the known high-quality news and/or the known low-quality news.

In block 202, the news feature characterizing the news quality discriminability is selected from the at least one candidate news feature as the training data, and the training data is marked with the known news quality level.

An implementation for realizing the block 202 is described as follows. An entropy of each of the at least one candidate news feature is calculated. Based on the entropy of each of the at least one candidate news feature, the news feature characterizing the news quality discriminability is selected from the at least one candidate news feature as the training data.

For example, the entropy of each of the at least one candidate news feature is calculated with a formula of

$$H ( ξ ) = - {\sum }_{n} {p}_{i} log {p}_{i} ,$$

n is the number of the known high-quality news and/or the number of the known low-quality news, i ranges from 1 to n, and pᵢ is a probability of a word or phrase p in all candidate news features of the known high-quality news or a probability of a word or phrase p in all candidate news features of the known low-quality news. Since the entropy is a parameter for describing randomness of objective things, the greater the entropy, the greater the uncertainty of events. Therefore, with regard to the characterization ability, the greater the entropy, the poorer the characterization ability, and the weaker the discriminability. Such that, a word having a best characterization ability (i.e. a smallest entropy) is selected from each news feature respectively based on the number of news features.

In block 203, the training data is learnt by adopting the machine learning classification algorithm to obtain the news quality classification model.

The adopted machine learning classification algorithm is a support vector machine (SVM) learning model.

In block 204, the news quality of the news to be detected is judged with the news quality classification model.

In the embodiments, by learning a large number of training data having known news quality to construct the news quality classification model, and by judging the news to be detected with the news quality classification model, the news containing high-quality ad (such as advertorial) may be effectively identified and a process of judging the news quality is smarter, thereby improving the efficiency and the accuracy in judging the news quality.

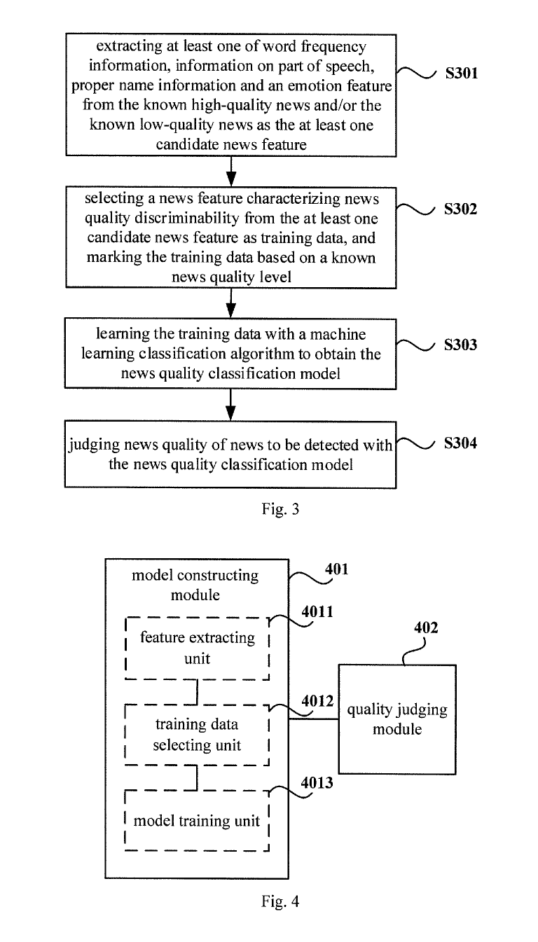

FIG. 3 is a flow chart illustrating a method for judging news quality based on AI according to still another embodiment of the present disclosure. This embodiment is optimized on the basis of the above embodiment(s). In embodiments, extracting the at least one candidate news feature from the known high-quality news and/or the known low-quality news is described as follows. At least one of word frequency information, information on part of speech, proper name information and an emotion feature is extracted from the known high-quality news and/or the known low-quality news as the at least one candidate news feature.

Accordingly, the method according to embodiments includes the followings.

In block 301, the at least one of the word frequency information, the word speech information, the proper name information and the emotion feature is extracted from the known high-quality news and/or the known low-quality news as the at least one candidate news feature.

In detail, a word and/or a phrase may be extracted from the known high-quality news and/or the known low-quality news, and statistic may be performed on the word and/or the phrase to obtain the word frequency information of the word and/or the phrase in a title field. For example, as a piece of news contains too many words, in order to reduce a computation amount, the title field may be selected to count an occurrence frequency of the word and/or the phrase, because the title field generally covers a product's name desired to be advertised and publicity intention. In order to avoid losing uncommon words having a meaning expression ability, the statistic is performed on both the word and the phrase to obtain the word frequency information.

Additionally or alternatively, the word or the phrase having the meaning expression ability may be extracted from a content field of the known high-quality news and/or the known low-quality news. Words contained in the word or the phrase are marked with part of speech to obtain the information on part of speech. For example, since the advertorial contains more adjectives, and the meaning expressions of verbs and the adjectives are positive, then the content field is marked with part of speech, and adjectives, nouns and verbs having the meaning expression ability are selected to form the information on part of speech. For example, the information on part of speech is (a, ad, an, n, nr, nt, nx, nz, Ag), “a” denotes an adjective, “ad” denotes an adverb, “an” denotes an adnoun (an adjective having a noun capacity), “n” denotes a noun, “nr” denotes a person's name, “nt” denotes an institution's name, “nx” denotes a proper name in foreign languages, “nz” denotes other proper names, and “Ag” denotes an adjective morpheme. If two nouns are adjacent or two adjectives are adjacent, the two adjacent nouns or the two adjacent adjectives form the phrase. The information on part of speech is calculated based on all words selected and all phrases selected.

Additionally or alternatively, one or more proper names contained in the content field of the known high-quality news and/or the known low-quality news are identified. The proper name information is formed with the identified proper names. For example, since all company's names and product's names may be identified from a piece of news when identifying the proper names, the proper names contained in the content filed may be identified.

Additionally or alternatively, one or more sentences contained in the known high-quality news and/or the known low-quality news are identified. Statistic is performed on the one or more sentences to obtain at least one of a first number of positive emotion sentences, a second number of neuter emotion sentences, and a third number of negative emotion sentences as the emotion feature. For example, as the advertorial mainly gives publicity to its products, the first number of the positive emotion sentences contained in the advertorial may be greater than the third number of the negative emotion sentences contained in the advertorial. Therefore, the first number, the second number and the third number corresponding respectively to the positive, neuter, and negative sentences contained in a piece of news are generally taken as three dimensional features of emotional tendency.

In block 302, the news feature characterizing the news quality discriminability is selected from the at least one candidate news feature as the training data. The training data is marked based on the known news quality level.

In block 303, the training data is learned by adopting the machine learning classification algorithm to obtain the news quality classification model.

In block 304, it is judged the news quality of the news to be detected with the news quality classification model.

In the embodiments, by extracting the word frequency information, the information on part of speech, the proper name information and the emotion feature of news whose news quality is known, by obtaining the news quality classification model via training, and by judging the news quality of the news to be detected by adopting the news quality classification model, the news containing high-quality ads (such as advertorials) may be effectively identified and a process of judging the news quality is smarter, thereby improving the efficiency and the accuracy in judging the news quality.

FIG. 4 is a block diagram illustrating a device for judging news quality based on AI according to an embodiment of the present disclosure. The embodiment may be applicable to a situation of judging the news quality. The device may be implemented in hardware and/or software. The device may be integrated into a terminal device or an application side of the terminal device. The terminal device may be, but not limited to, a mobile terminal (such as a tablet computer or a smart phone), a fixed terminal (such as a desktop computer or a laptop).

The application side may be a plug-in embedded in a certain client of the terminal device, or may be a plug-in of an operating system of the terminal device, cooperating with a client embedded in the terminal device for judging the news quality based on AI or with an application program in the operating system of the terminal device for judging the news quality based on AI. Alternatively, the application side may also be a separate client in the terminal device, which is able to provide news quality judgment based on AI. The embodiments are not limited thereto.

As illustrated in FIG. 4, the device includes a model constructing module 401 and a quality judging module 402.

The model constructing module 401 is configured to construct a news quality classification model based on a news feature of known high-quality news and/or a news feature of known low-quality news.

The quality judging module 402 is configured to judge news quality of news to be detected with the news quality classification model.

The device for judging the news quality based on AI according to the embodiment is configured to execute the method for judging the news quality based on AI according to the above embodiments, the technical principles and technical effects caused are similar, which are not elaborated herein.

On the basis of the above embodiments, the model constructing module 401 includes a feature extracting unit 4011, a training data selecting unit 4012 and a model training unit 4013.

The feature extracting unit 4011 is configured to extract at least one candidate news feature from the known high-quality news and/or the known low-quality news based on a preset news quality judgement rule.

The training data selecting unit 4012 is configured to select a news feature characterizing news quality discriminability from the at least one candidate news feature as training data, and to mark the training data based on a known news quality level.

The model training unit 4013 is configured to learn the training data with a machine learning classification algorithm to obtain the news quality classification model.

On the basis of the above embodiments, the feature extracting unit 4011 is configured to extract at least one of word frequency information, information on part of speech, proper name information and an emotion feature from the known high-quality news and/or the known low-quality news as the at least one candidate news feature.

On the basis of the above embodiments, the feature extracting unit 4011 is configured to extract a word and/or a phrase from the known high-quality news and/or the known low-quality news, and to perform statistic on the word and/or the phrase to obtain the word frequency information of the word and/or the phrase in a title field.

On the basis of the above embodiments, the feature extracting unit 4011 is configured to extract a word or a phrase having a meaning expression ability from a content field of the known high-quality news and/or the known low-quality news, and to mark words contained in the word or the phrase with part of speech so as to obtain the information on part of speech.

On the basis of the above embodiments, the feature extracting unit 4011 is configured to identify one or more proper names contained in a content field of the known high-quality news and/or the known low-quality news, and to form the proper name information with the identified proper names.

On the basis of the above embodiments, the feature extracting unit 4011 is configured to identify one or more sentences contained in the known high-quality news and/or the known low-quality news, to perform statistic on the one or more sentences to obtain at least one of a first number of positive emotion sentences, a second number of neuter emotion sentences, and a third number of negative emotion sentences as the emotion feature.

On the basis of the above embodiments, the training data selecting unit 4012 is configured to calculate a entropy of each of the at least one candidate news feature, and select the news feature characterizing the news quality discriminability from the at least one candidate news feature as the training data based on the entropy of each of the at least one candidate news feature.

On the basis of the above embodiments, the news quality judgment rule includes at least one of: whether brand information is contained, whether product information is contained, news publicity intention, an occurrence frequency of a product name and/or a brand name in an article, whether meaning indications of words are positive, and whether word styles are exaggerated.

The device for judging the news quality based on AI according to the embodiment is configured to execute the method for judging the news quality based on AI according to the above embodiments, having functional modules corresponding to the method for judging the news quality based on AI and same technical effects.

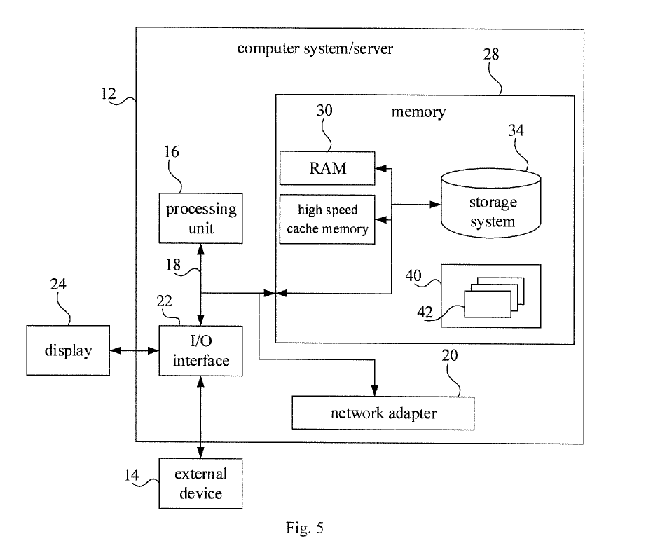

FIG. 5 is a schematic diagram illustrating an apparatus according to an embodiment of the present disclosure. FIG. 5 shows a block diagram of an exemplary computer apparatus 12 that is applicable to realize implementations of the present disclosure. The computer apparatus illustrated as FIG. 5 is merely an example, which does not limit functions and usage scopes of embodiments of the present disclosure.

As illustrated in FIG. 5, the computer apparatus 12 is implemented as a general computation apparatus. Components of the computer apparatus 12 may include but be not limited to: one or more processors or processing units 16; a system memory 28; and a bus 18 connecting various system components including the system memory 28 and the processing units 16.

The bus 18 represents one or more of several types of bus structures, including a memory bus or a memory controller, a peripheral bus, a graphics acceleration port, a processor, or a local bus using any of a variety of bus structures. For example, these structures include, but are not limited to, an Industry Standard Architecture (ISA) bus, a Micro Channel Architecture (MAC) bus, an enhanced ISA bus, a Video Electronics Standards Association (VESA) local bus and a Peripheral Component Interconnection (PCI) bus.

The computer apparatus 12 typically includes a variety of computer system readable media. These media may be any available media accessible by the computer apparatus 12 and includes both volatile and non-volatile media, removable and non-removable media.

The system memory 28 may include a computer system readable medium in the form of volatile memory, such as a random access memory (RAM) 30 and/or a high speed cache memory 32. The computer apparatus 12 may further include other removable or non-removable, volatile or non-volatile computer system storage media. By way of example only, the storage system 34 may be configured to read and write a non-removable and non-volatile magnetic media (not shown in FIG. 5, commonly referred to as a “hard driver”). Although not shown in FIG. 5, a magnetic disk driver for reading from and writing to a removable and non-volatile magnetic disk (such as “floppy disk”) and a disk driver for a removable and non-volatile optical disk (such as CD-ROM, DVD-ROM or other optical media) may be provided. In these cases, each driver may be connected to the bus 18 via one or more data medium interfaces. The memory 28 may include at least one program product. The program product has a set (such as, at least one) of program modules configured to perform the functions of various embodiments of the present disclosure.

A program/utility 40 having a set (at least one) of the program modules 42 may be stored in, for example, the memory 28. Such the program modules 42 include but are not limited to, an operating system, one or more application programs, other programs modules, and program data. Each of these examples, or some combination thereof, may include an implementation of a network environment. The program modules 42 generally perform the functions and/or methods in the embodiments described herein.

The computer apparatus 12 may also communicate with one or more external devices 14 (such as, a keyboard, a pointing device, a display 24, etc.). Furthermore, the computer apparatus 12 may also communicate with one or more communication devices enabling a user to interact with the computer apparatus 12 and/or other devices (such as a network card, modem, etc.) enabling the computer apparatus 12 to communicate with one or more computer devices. This communication can be performed via the input/output (I/O) interface 22. Also, the computer apparatus 12 may communicate with one or more networks (such as a local area network (LAN), a wide area network (WAN) and/or a public network such as an Internet) through a network adapter 20. As shown in FIG. 5, the network adapter 20 communicates with other modules of the computer apparatus 12 over the bus 18. It should be understood that, although not shown in FIG. 5, other hardware and/or software modules may be used in combination with the computer apparatus 12. The hardware and/or software includes, but is not limited to, microcode, device drivers, redundant processing units, external disk drive arrays, RAID systems, a magnetic tape driver and a data backup storage system.

The processing unit 16 is configured to execute various functional applications and data processing by running programs stored in the system memory 28, for example, implementing the method for judging news quality based on AI according to embodiments of the present disclosure. The method for judging news quality based on AI includes the followings.

A news quality classification model is constructed based on a news feature of known high-quality news and/or a news feature of known low-quality news.

News quality of news to be detected is judged with the news feature classification model.

The embodiment of the present disclosure further provides a computer readable storage medium having computer programs stored therein. When the computer programs are executed by a processor, the method for judging news quality based on AI according to embodiments of the present disclosure is executed. The method for judging news quality based on AI includes the followings.

A news quality classification model is constructed based on a news feature of known high-quality news and/or a news feature of known low-quality news.

News quality of news to be detected is judged with the news feature classification model.

Any combination of one or more computer readable media may be adopted for the computer storage medium according to embodiments of the present disclosure. The computer readable medium may be a computer readable signal medium or a computer readable storage medium. The computer readable storage medium may be, but is not limited to, for example, an electrical, magnetic, optical, electromagnetic, infrared, or semiconductor system, apparatus, device, component or any combination thereof. Specific examples of the computer readable storage media include (a non-exhaustive list): an electrical connection having one or more wires, a portable computer disk, a hard disk, a random access memory (RAM), a read only memory (ROM), an Erasable Programmable Read Only Memory (EPROM) or a flash memory, an optical fiber, a compact disc read-only memory (CD-ROM), an optical memory component, a magnetic memory component, or any suitable combination thereof. In the present disclosure, the computer readable storage medium may be any tangible medium including or storing programs. The programs may be used by an instruction executable system, apparatus or device, or a combination thereof.

The computer readable signal medium may include a data signal propagating in baseband or as part of a carrier which carries computer readable program codes. Such propagated data signal may be in many forms, including but not limited to an electromagnetic signal, an optical signal, or any suitable combination thereof. The computer readable signal medium may also be any computer readable medium other than the computer readable storage medium, which may send, propagate, or transport programs used by an instruction executed system, apparatus or device, or a connection thereof.

The program code stored on the computer readable storage medium may be transmitted using any appropriate medium, including but not limited to wireless, wireline, optical fiber cable, RF, or any suitable combination thereof.

The computer program code for carrying out operations of embodiments of the present disclosure may be written in one or more programming languages. The programming languages include an object oriented programming language, such as Java, Smalltalk, C++, as well as a conventional procedural programming language, such as “C” language or similar programming language. The program code may be executed entirely on a user's computer, partly on the user's computer, as a separate software package, partly on the user's computer and partly on a remote computer, or entirely on the remote computer or server. In a case of the remote computer, the remote computer may be connected to the user's computer through any kind of network, including a local area network (LAN), or may be connected to a wide area network (WAN) or an external computer (such as using an Internet service provider to connect over the Internet).

It should be noted that, the above descriptions are only preferred embodiments of the present disclosure and applied technical principles. Those skilled in the art should understand that the present disclosure is not limited to the specific embodiments described herein, and various apparent changes, readjustments and replacements can be made by those skilled in the art without departing from the scope of the present disclosure. Therefore, although the present disclosure has been described in detail by way of the above embodiments, the present disclosure is not limited only to the above embodiments and more other equivalent embodiments may be included without departing from the concept of the present disclosure. However, the scope of the present disclosure is determined by appended claims.

What is claimed is:

1. A method for judging news quality based on artificial intelligence, comprising:
constructing a news quality classification model based on a news feature of known high-quality news and/or a news feature of known low-quality news; and
judging news quality of news to be detected with the news quality classification model.

2. The method according to claim 1, wherein constructing the news quality classification model based on the news feature of the known high-quality news and/or the news feature of the known low-quality news comprises:
extracting at least one candidate news feature from the known high-quality news and/or the known low-quality news based on a preset news quality judgement rule;
selecting a news feature characterizing news quality discriminability from the at least one candidate news feature as training data, and marking the training data based on a known news quality level; and
learning the training data with a machine learning classification algorithm to obtain the news quality classification model.

3. The method according to claim 2, wherein extracting the at least one candidate news feature from the known high-quality news and/or the known low-quality news comprises:
extracting at least one of word frequency information, information on part of speech, proper name information and an emotion feature from the known high-quality news and/or the known low-quality news as the at least one candidate news feature.

4. The method according to claim 3, wherein, extracting the word frequency information from the known high-quality news and/or the known low-quality news comprises:
extracting a word and/or a phrase from the known high-quality news and/or the known low-quality news, and performing statistic on the word and/or the phrase to obtain the word frequency information of the word and/or the phrase in a title field.

5. The method according to claim 3, wherein, extracting the information on part of speech from the known high-quality news and/or the known low-quality news comprises:
extracting a word or a phrase having a meaning expression ability from a content field of the known high-quality news and/or the known low-quality news; and
marking words contained in the word or the phrase with part of speech to obtain the information on part of speech.

6. The method according to claim 3, wherein, extracting the proper name information from the known high-quality news and/or the known low-quality news comprises:
identifying one or more proper names contained in a content field of the known high-quality news and/or the known low-quality news, and forming the proper name information with the identified proper names.

7. The method according to claim 3, wherein, extracting the emotion feature from the known high-quality news and/or the known low-quality news comprises:
identifying one or more sentences contained in the known high-quality news and/or the known low-quality news, and performing statistic on the one or more sentences to obtain at least one of a first number of positive emotion sentences, a second number of neuter emotion sentences, and a third number of negative emotion sentences as the emotion feature.

8. The method according to claim 2, wherein selecting the news feature characterizing the news quality discriminability from the at least one candidate news feature as the training data comprises:
calculating a entropy of each of the at least one candidate news feature; and
selecting the news feature characterizing the news quality discriminability from the at least one candidate news feature as the training data based on the entropy of each of the at least one candidate news feature.

9. The method according to claim 2, wherein, the news quality judgement rule comprises at least one of:
whether brand information is contained, whether product information is contained, news publicity intention, an occurrence frequency of a product name and/or a brand name in an article, whether meaning indications of words are positive, and whether word styles are exaggerated.

10. An apparatus, comprising:
one or more processors;
a storage device, configured to store one or more programs;
wherein the one or more processors are configured to execute the one or more programs by reading from the storage device to perform acts of:
constructing a news quality classification model based on a news feature of known high-quality news and/or a news feature of known low-quality news; and
judging news quality of news to be detected with the news quality classification model.

11. The apparatus according to claim 10, wherein the one or more processors are configured to construct the news quality classification model based on the news feature of the known high-quality news and/or the news feature of the known low-quality news by acts of:
extracting at least one candidate news feature from the known high-quality news and/or the known low-quality news based on a preset news quality judgement rule;
selecting a news feature characterizing news quality discriminability from the at least one candidate news feature as training data, and marking the training data based on a known news quality level; and
learning the training data with a machine learning classification algorithm to obtain the news quality classification model.

12. The apparatus according to claim 11, wherein the one or more processors are configured to extract the at least one candidate news feature from the known high-quality news and/or the known low-quality news by acts of:
extracting at least one of word frequency information, information on part of speech, proper name information and an emotion feature from the known high-quality news and/or the known low-quality news as the at least one candidate news feature.

13. The apparatus according to claim 12, wherein the one or more processors are configured to extract the word frequency information from the known high-quality news and/or the known low-quality news by acts of:
extracting a word and/or a phrase from the known high-quality news and/or the known low-quality news, and performing statistic on the word and/or the phrase to obtain the word frequency information of the word and/or the phrase in a title field.

14. The apparatus according to claim 12, wherein the one or more processors are configured to extract the word frequency information from the known high-quality news and/or the known low-quality news by acts of:
extracting a word or a phrase having a meaning expression ability from a content field of the known high-quality news and/or the known low-quality news; and
marking words contained in the word or the phrase with part of speech to obtain the information on part of speech.

15. The apparatus according to claim 12, wherein the one or more processors are configured to extract the word frequency information from the known high-quality news and/or the known low-quality news by acts of:
identifying one or more proper names contained in a content field of the known high-quality news and/or the known low-quality news, and forming the proper name information with the identified proper names.

16. The apparatus according to claim 12, wherein the one or more processors are configured to extract the word frequency information from the known high-quality news and/or the known low-quality news by acts of:
identifying one or more sentences contained in the known high-quality news and/or the known low-quality news, and performing statistic on the one or more sentences to obtain at least one of a first number of positive emotion sentences, a second number of neuter emotion sentences, and a third number of negative emotion sentences as the emotion feature.

17. The apparatus according to claim 11, wherein the one or more processors are configured to select the news feature characterizing the news quality discriminability from the at least one candidate news feature as the training data by acts of:
calculating a entropy of each of the at least one candidate news feature; and
selecting the news feature characterizing the news quality discriminability from the at least one candidate news feature as the training data based on the entropy of each of the at least one candidate news feature.

18. The apparatus according to claim 11, wherein, the news quality judgement rule comprises at least one of:
whether brand information is contained, whether product information is contained, news publicity intention, an occurrence frequency of a product name and/or a brand name in an article, whether meaning indications of words are positive, and whether word styles are exaggerated.

19. A non-transitory computer readable storage medium, having computer programs stored therein, wherein when the computer programs are executed by a processor, a method for judging news quality based on artificial intelligence is realized, the method comprising:
constructing a news quality classification model based on a news feature of known high-quality news and/or a news feature of known low-quality news; and
judging news quality of news to be detected with the news quality classification model.

20. The non-transitory computer readable storage medium according to claim 19, wherein constructing the news quality classification model based on the news feature of the known high-quality news and/or the news feature of the known low-quality news comprises:
extracting at least one candidate news feature from the known high-quality news and/or the known low-quality news based on a preset news quality judgement rule;
selecting a news feature characterizing news quality discriminability from the at least one candidate news feature as training data, and marking the training data based on a known news quality level; and
learning the training data with a machine learning classification algorithm to obtain the news quality classification model.
